(19) United States
(12) Patent Application Publication
(10) Pub. No.: US 2023/0226610 A1
(43) Pub. Date: Jul. 20, 2023

(54) METHOD FOR MANUFACTURING A TARGET MATERIAL

(71) Applicant: TAIWAN STEEL GROUP AEROSPACE ADDITIVE MANUFACTURING CORPORATION, Tainan City (TW)

(72) Inventors: William HSIEH, Tainan City (TW); Bo-Chen WU, Tainan City (TW); Jun-Cheng WANG, Tainan City (TW)

(73) Assignee: TAIWAN STEEL GROUP AEROSPACE ADDITIVE MANUFACTURING CORPORATION, Tainan City (TW)

(21) Appl. No.: 17/846,353

(22) Filed: Jun. 22, 2022

(30) Foreign Application Priority Data
Jan. 18, 2022 (TW) 111102011

(51) Int. Cl. B22F 10/28; B22F 12/67; B22F 12/41; B22F 12/49; B22F 12/50; B22F 10/66; B33Y 10/00; B33Y 40/10

(52) U.S. Cl. CPC B22F 10/28; B22F 12/67; B22F 12/41; B22F 12/49; B22F 12/50; B22F 10/66; B33Y 10/00; B33Y 40/10; B22F 2201/02; B22F 2304/10; B33Y 40/20

(57) ABSTRACT

A method for manufacturing a target material is provided and includes installing a substrate, providing a raw material powder to the substrate, melting the raw material powder on the substrate by a laser, and repeating the step of providing the raw material powder to the substrate to melting the raw material powder on the substrate by the laser to form a target material and rapidly cooling the formed target material. As such, the target material is produced by the method of lamination manufacturing via the rapid cooling property, so as to avoid the problems of high cost, long man-hours and poor quality of the target material in the conventional techniques.

### BACKGROUND

### 1. Technical Field

The present disclosure relates to a method for manufacturing a target material, and more particularly, to a method for forming a target material in a lamination manufacturing process and rapidly solidifying the formed target material.

### 2. Description of Related Art

Sputtering is a physical vapor deposition technique, which is used to deposit a set target material on a surface of a target object to form a thin film of a material corresponding to the target material. For example, in an application of components of computer equipment, an alloy sputtering target material formed of iron, cobalt, chromium and boron can be used to apply to a soft magnetic layer on a hard disk drive (HDD), wherein a thickness of the soft magnetic layer is almost a sum of thicknesses of the other film layers, and the soft magnetic layer is the target material with the greatest demand.

In the process of applying sputtering, a quality of the target material used often determines a quality of a sputtering result. In the past two decades, the production of the target material has evolved from the Vacuum Induction Melting (VIM) process, which has been replaced by conventional Powder Metallurgy (PM). The target material produced by the PM process has fine grains, which has the advantage of improving the performance of the sputtering film. Therefore, the current sputtering target material is usually produced by the PM process. However, in the conventional target material manufacturing process, the problem of boron precipitation is prone to occur, which will cause the problem of poor target material quality. Furthermore, the conventional target material manufacturing process has the problems of high labor and power costs, long man-hours, distortion and deformation of important parts of the sintered body, and loss of post-processing materials.

From the above, it can be seen that how to provide a better method for manufacturing a target material is really important to prevent boron precipitation (which affects the quality of the target material), reduce manufacturing costs and man-hours, and reduce other problems that cause poor quality of the target material during the manufacturing process. Therefore, how to overcome the above-mentioned flaws of the prior art has become an urgent issue to be solved at present.

### SUMMARY

In view of the various deficiencies of the prior art, the present disclosure provides a method for manufacturing a target material, which is performed by a computer equipment, comprising the following steps: installing a substrate; spreading a raw material powder on the substrate by a scraper to form a powder layer; melting the raw material powder of the powder layer by a laser according to a plane size of the target material; forming another powder layer on the substrate and the melted raw material powder; melting a raw material powder of the another powder layer by the laser to form a desired height of the target material according to the plane size of the target material; and cooling the target material. In one embodiment, the target material can be a hard disk sputtering target material.

In one embodiment, the raw material powder is a powder including iron, cobalt, chromium and boron.

In another embodiment, before the step of forming the powder layer on the substrate, the present disclosure further comprises the following steps: performing a coarse screening for a coarse powder screening of the raw material powder via a coarse screen to obtain the raw material powder in fine powder form; and performing a fine screening for a fine powder screening of the raw material powder via a fine screen to obtain the raw material powder with a particle size of about 20 μm to 70 μm and a powder flowability of less than 16%.

In another embodiment, the coarse screening for the coarse powder screening and the fine screening for the fine powder screening are performed by an oscillating screen equipment.

In another embodiment, the raw material powder is stored in a powder feeding tank, and the step of forming the powder layer on the substrate is to make the scraper sequentially take out the raw material powder from the powder feeding tank that is enough to lay flat on the substrate to form the powder layer.

In another embodiment, the laser has a power of 140 W and a scanning speed of 900 mm/s.

In another embodiment, the substrate is installed in a construction cabin, and the steps of forming the powder layer on the substrate, melting the powder layer by the laser and cooling the target material are performed in the construction cabin.

In another embodiment, the construction cabin is filled with inert gas or nitrogen gas.

In another embodiment, the scraper and a surface of the substrate are kept parallel to each other with a thickness formed by the powder layer as a distance.

In a further embodiment, before performing the step of installing the substrate, the present disclosure further comprises the following steps: grinding a surface of the substrate.

To sum up, the manufacturing method of the target material according to the present disclosure is to repeatedly perform, through a manner of lamination manufacturing, the steps of laying a raw material powder on a substrate to form a powder layer and melting the powder layer by a laser, so as to form a target material, and finally, the target material is rapidly cooled to achieve the purpose of improving the density and quality of the target material, and can achieve the effect of preventing boron precipitation. Further, the present disclosure manufactures a target material by using a lamination manufacturing process to melt a raw material powder at a high temperature by a laser and rapidly solidify the target material, so that the produced target material has a finer and more uniform microstructure of a hard disk target, in order to provide better film characteristics and sputtering efficiency. For example, when making hard disk discs, it is more helpful to control the quality of the disc.

### BRIEF DESCRIOPTION OF THE DRAWINGS

FIG. 1 is a flow chart of steps illustrating a manufacturing method of a target material according to the present disclosure.

FIGS. 2A to 2E are schematic views of implementation states illustrating the manufacturing method of the target material according to the present disclosure.

FIGS. 3A to 3C are schematic views of a structure of the target material produced by the manufacturing method of the target material according to the present disclosure.

### DETAILED DESCRIPTIONS

The following describes the implementation of the present disclosure with examples. Those skilled in the art can easily understand other advantages and effects of the present disclosure from the contents disclosed in this specification. However, the present disclosure can also be implemented or applied by other different embodiments.

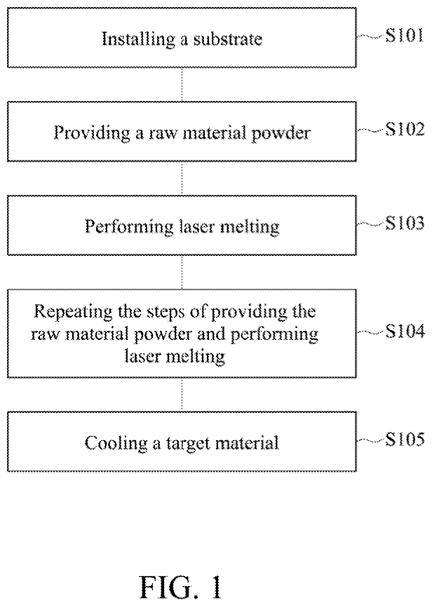

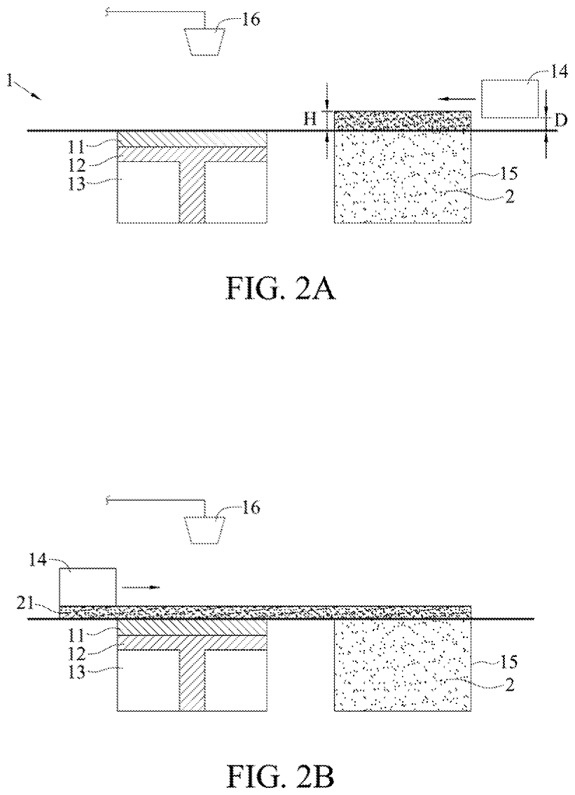

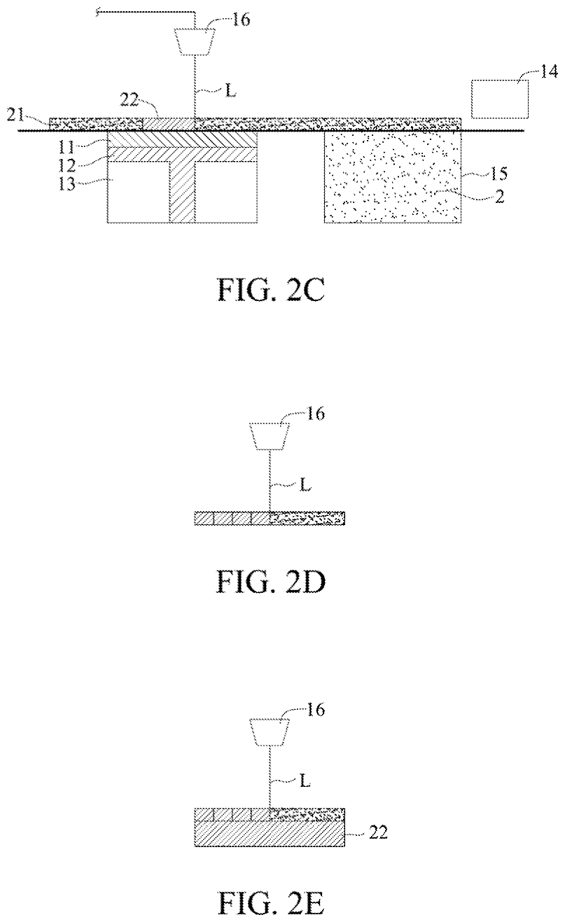

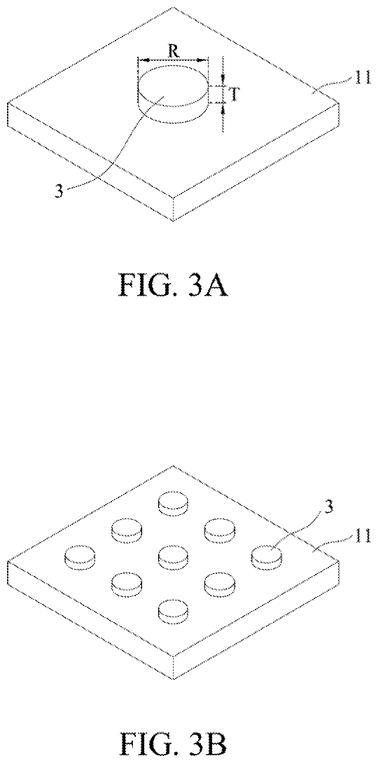

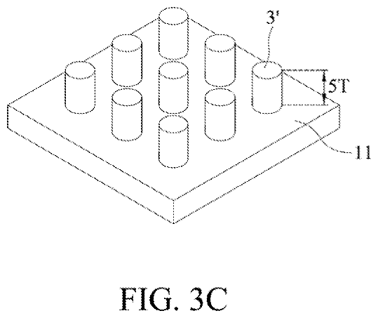

FIG. 1 is a flow chart of steps illustrating a manufacturing method of a target material according to the present disclosure, FIGS. 2A to 2C are schematic views of an implementation state illustrating the manufacturing method of the target material according to the present disclosure, and FIGS. 3A to 3C are schematic views of a structure of the target material produced by the manufacturing method of the target material according to the present disclosure. The manufacturing method of the target material according to the present disclosure can be executed in a computer equipment or a processing equipment with the computer equipment, that is, the computer equipment sends out corresponding control instructions based on the set parameters, so that processing elements such as scrapers or lasers generate corresponding operations.

As shown in FIG. 1, the manufacturing method of the target material according to the present disclosure includes the following steps. In step S101, a substrate 11 is installed and fixed (e.g., screw-locked) at a place to be processed. The substrate 11 is a metal substrate, and is used to provide a working area for processing, so as to gradually form a desired target material on the working area. In an embodiment, as shown in FIGS. 2A to 2C, in the present disclosure, the substrate 11 can be installed and fixed on a processing machine 1 for processing and manufacturing the target material, but it is not limited thereto.

As shown in FIG. 2A, the processing machine 1 may include a substrate carrier 12 located in a processing tank 13 and can be moved up and down in the processing tank 13 for the substrate 11 to be fixed on the substrate carrier 12. The substrate carrier 12 drives the substrate 11 to move up and down in the processing tank 13 according to a setting during the manufacturing process of the target material. When the substrate 11 is installed, the substrate 11 is firstly fixed on the substrate carrier 12 by means of locking, and a gap D between the substrate and the scraper and a level of the substrate can be corrected by a feeler gauge, so as to prevent the subsequent uneven powder spreading. After the substrate 11 is installed on the processing machine 1, the installed substrate 11 can be lowered into the processing tank 13, so that a surface of the substrate 11 is flush with an opening of the processing tank 13.

In addition, before installing the substrate 11, a pre-operation can be performed in advance, and the steps of the pre-operation are described as follows.

First, prepare the substrate 11, that is, the surface of the substrate 11 is ground. If the substrate 11 has been subjected to the manufacturing process of the target material, the previously printed product of the target material is first removed from the substrate 11, and then a surface grinder is used to grind an upper and a lower planes of the substrate to obtain the substrate 11 with better flatness and parallelism, so as to reduce the variation factors of subsequent printing production.

Furthermore, in order to clean the processing machine 1, an anti-static brush is used to remove raw material powder left over from the previous manufacturing process of the target material in the processing machine 1, and then a wiping paper is used in combination with anhydrous alcohol for cleaning.

Also, the scraper 14 may be cleaned or replaced. If it is only for cleaning the scraper 14, anhydrous alcohol may be used to clean the surface of the scraper 14, so as to prevent residual powder on a contact surface contacting the raw material powder, causing the scraper 14 to be uneven; if the scraper 14 is to be replaced, the scraper 14 must be removed first, the raw material powder adhering on the surface of the scraper 14 must be removed with a brush, and after removing an upper base (not shown), which is for the scraper 14 to be installed, on the processing machine 1 and the scraper 14, it must also be cleaned with anhydrous alcohol to prevent powder residue on the contact surface, which may cause the scraper 14 to be installed unevenly.

In step S102, a raw material powder 2 is provided, and then the raw material powder 2 is spread on the substrate 11 by the scraper 14 to form a powder layer 21. The raw material powder 2 may include a mixed powder of iron powder, cobalt powder, chromium powder and boron powder. As shown in FIGS. 2A and 2B, the scraper 14 is installed on the processing machine 1 in such a manner that the scraper 14 may move freely to left and right (as shown by a left or a right arrow in FIGS. 2A and 2B), and the gap D between the scraper 14 and the surface of the substrate 11 is used as a thickness of the powder layer 21, that is, the gap D (or the thickness of the powder layer formed) is used as a distance, so that the scraper 14 and the surface of the substrate 11 are kept parallel to each other. In an embodiment, the raw material powder 2 is stored in a powder feeding tank 15, so that the scraper 14 sequentially takes out the raw material powder 2 from the powder feeding tank 15 that is enough to lay flat on the substrate 11 to form the powder layer 21, that is, the powder feeding tank 15 for storing the raw material powder 2 can be recessed in the processing machine 1 adjacent to the processing tank 13. After the raw material powder 2 is added into the powder feeding tank 15, the scraper 14 can be used to level the surface, and a layer of the powder layer 21 is left on the substrate 11; when the powder feeding tank 15 is supplying the raw material powder 2, the raw material powder 2 stored therein is lifted upward, so that the raw material powder 2 located on an upper part of the powder feeding tank 15 is exposed to a height H (the height H is greater than the gap D) of the powder feeding tank 15, such that when the scraper 14 moves to the left (as shown by the arrow in FIG. 2A), the raw material powder 2 exposed from the powder feeding tank 15 is scraped to the substrate 11, and the raw material powder 2 on the substrate 11 is leveled by the movement of the scraper 14, so that the raw material powder 2 is spread on the substrate 11 to form the powder layer 21.

In one embodiment, before the raw material powder 2 is provided, the raw material powder 2 can be screened to obtain a better raw material powder 2, and the quality of the produced target material can be improved accordingly. For instance, the present disclosure utilizes an oscillating screen equipment to perform a screening of the raw material powder 2. The steps of screening the raw material powder 2 are described as follows.

Coarse powder screening is to coarsely screen the raw material powder through a coarse screen to obtain a fine powdery raw material powder 2. That is, through the screen, a mechanical oscillating screen is used to screen out the powder with excessive particle size (for example, the powder with a particle size larger than 70 μm), and when the raw material powder has agglomeration phenomenon, the agglomerated raw material is divided into pieces for coarse screening. For example, the initial raw material powder 2 may include agglomerates, granules, or powders with larger particle size, so they are screened out by a screen with a mesh smaller than the aforementioned powders with larger particle size, so as to retain the fine powdery raw material powder 2.

Fine powder screening is to finely screen the raw material powder 2 in a fine powder form through a fine screen to obtain the raw material powder 2 with a particle size of about 20 μm to 70 μm and a powder flowability of less than 16%. For instance, in the present disclosure, a cyclone powder classifier can be used to screen the fine powder with too small particle size by a centrifugal force, so as to ensure the processing quality of the subsequent procedures.

In step S103, a laser melting is performed. It uses a laser 16 to melt the powder layer according to a plane size of the target material, and the plane size of the target material is a size parameter of a top view plane of the target material. For example, when the target material is in the shape of a square cake, its plane size is a side length or parameters of a length and a width of the square cake-shaped target material. In another embodiment, as shown in FIG. 3A, if a target material 3 is in the shape of a round cake, its plane size is a diameter R (or radius). The present disclosure is described here by taking the shape of the target material in the shape of a round cake as an example. In one embodiment, as shown in FIG. 2C, the laser 16 can be installed on the processing machine 1, and controlled by the processing machine 1, so that a laser light L can be emitted to the raw material powder on the substrate, and the raw material powder 2 is scanned according to the setting, so that the raw material powder 2 scanned by the laser light L is melted and sintered. As shown in FIG. 2D, the laser light L can melt and sinter the raw material powder 2 by scanning line by line, so as to form a layer of a target material layer 22 in the powder layer 21 after the scanning operation of the laser 16 is completed. In one embodiment, the power of the laser 16 is 140 W, and the scanning speed is 900 mm/s.

In step S104, in order to achieve a desired height size of the target material 3, the supply of the raw material powder and the laser melting are performed repeatedly, that is, the steps of providing another powder layer and melting a raw material powder of the another powder layer with the laser according to the plane size of the target material are continuously performed on the substrate and the melted raw material powder (that is, the target material layer 22 that has been formed). As shown in FIG. 2E, the another powder layer is scanned line by line through the laser light L to form another target material layer on the formed target material layer 22, so as to achieve the desired height of the target material by stacking multiple target material layers. Here, after the supply of the raw material powder is performed once, that is, after the steps of forming the powder layer and the laser melting to obtain the target material layer 22, the substrate carrier 12 of the processing machine 1 must be lowered by a distance of the height H, so that the surface of the target material layer 22 is flush with the opening of the processing tank 13, and then the steps of forming another powder layer and laser melting are performed to obtain another target material layer stacked on the target material layer 22. In addition, the powder feeding tank 15 is made to expose more raw material powder 2 upward, so as to perform the step of supplying the raw material powder and laser melting another time. When the height of the stacked target material layers 22 to be repeated reaches a height T of the target material, the target material 3 is formed. And as shown in FIG. 3A, the height size of the target material 3 is the height T of the target material 3 when viewed from the side. In addition, as shown in FIG. 3C, a columnar target material 3′ with a height size of 5T can also be further formed, that is, a height that is five times the aforementioned height T. For example, if a desired thickness of the target material is 3 cm, and the thickness of the target material layer 22 that can be obtained by performing the steps of supplying raw material powder and laser melting once is 3 mm, then the steps of supplying raw material powder and laser melting need to be performed ten times.

In step S105, the target material is cooled. Preferably, the target material 3 can be rapidly cooled, so that the target material 3 is rapidly solidified. For instance, the present disclosure performs cooling of the target material 3 at a high cooling rate of 106° C./sec, so that the target material 3 is rapidly solidified. Moreover, the cooling rate can be controlled through parameters such as the laser scanning rate, that is, by optimizing the laser parameters, to confirm an optimal cooling rate for refining the target grains, so as to prevent the precipitation of boron materials.

As shown in FIG. 3A, the present disclosure can form a single target material 3 in a single process, or as shown in FIG. 3B, can also form a plurality of target materials 3 in a single process, wherein the formed target material can be a target material for hard disk sputtering. That is, according to the present disclosure, a single target material 3 or a plurality of target materials 3 can be obtained at one time as required.

In an embodiment, the processing machine 1 according to the present disclosure may include a construction cabin (not shown) for providing a processing operation environment, and the construction cabin is a closed cabin that can be filled with inert gas or nitrogen gas, and includes a hatch for the user to operate. Therefore, the substrate 11 is installed in the construction cabin, and the steps of supplying raw material powder, laser melting and cooling the target material are performed in the construction cabin, so the manufacturing method of the target material according to the present disclosure can be carried out in an automated manner via the processing machine 1 having the construction cabin. That is, after installing the substrate 11 and adding enough raw material powder 2 for processing into the powder feeding tank 15, the following steps are performed.

First, a step of closing the hatch is performed. That is, after the hardware setting (such as installing the substrate, adding raw material powder) has been completed, the hatch of the construction cabin is closed, and then nitrogen gas is input and the substrate 11 is heated until it reaches the set condition (such as 150° C.), so that the preparation for being able to print (i.e., making the target material) at any time is completed. In one embodiment, the processing machine 1 includes a computer equipment for inputting set parameters for automatic control, so as to allow the user to input the parameters required for the manufacturing method of the target material according to the present disclosure (for example, the power, scanning speed, etc. of the above-mentioned laser).

Then, a step of preparing a drawing is performed. The user first uses a drawing software to complete a 3D (three-dimensional) geometry of the desired product, and then imports it into a software corresponding to the computer equipment of the processing machine 1 for subsequent settings.

Finally, a step of setting the software is performed. After the drawing is prepared and imported into the computer equipment of the processing machine 1, it is necessary to determine the position of the substrate and set the printing parameters, the parameters include the thickness of the powder layer, the temperature of the substrate, the laser power, and the scanning rate, etc.

In an embodiment, the present disclosure can utilize a selective laser melting (SLM) equipment to set the above-mentioned parameters and perform the above-mentioned steps.

Therefore, the present disclosure can be applied to a processing process of a sputtering target material of iron cobalt chromium boron alloy. The processing process uses a screening machine to obtain raw material powder 2 with appropriate particle size (such as a particle size of about 20 μm to 70 μm and a powder flowability of less than 16%). Then, appropriate parameters (such as 140 W laser power, or 900 mm/s laser scanning speed) are selected to make the raw material powder 2 into the target material 3 by the processing machine 1, and then the target material 3 is tempered and reprocessed in the subsequent process. Therefore, the present disclosure utilizes the uniqueness of the process of rapidly solidifying the raw material powder 2 after melting to form a target material, which can effectively increase the density of the target material and reduce the precipitation phase of boride. That is, the present disclosure is a rapid solidification process (RSP) in the manner of lamination manufacturing through a laser, so it can improve an alloy adding ability and refine the microstructure. Furthermore, compared with the conventional powder metallurgy process, the present disclosure can make the microstructure of the target material 3 more detailed, uniform and dense, improve the quality of the sputtering target material and form a sputtering film with better performance, and can achieve the purpose of maximizing the service life of the target material 3. The present disclosure utilizes the advantages of the One Net Shape Forming process of the lamination manufacturing process, which can further reduce the loss of the material post-processing process, and can reduce the manufacturing process, and also has the commercialization capability of single-batch mass production of target materials. Therefore, compared with the conventional powder metallurgy process, the manufacturing method according to the present disclosure can greatly reduce the production cost.

To sum up, the manufacturing method of the target material according to the present disclosure is to repeatedly perform, through a manner of lamination manufacturing, the steps of laying a raw material powder 2 on a substrate 11 to form a powder layer 21 and melting the powder layer 21 by a laser, so as to form a target material, and finally, the target material 3 is rapidly cooled to achieve the purpose of improving the density and quality of the target material 3, and can achieve the effect of preventing boron precipitation. In other words, the present disclosure manufactures a target material by using a lamination manufacturing process to melt a raw material powder at a high temperature by a laser and rapidly solidify the target material, so that the produced target material has a finer and more uniform microstructure of a hard disk target, in order to provide better film characteristics and sputtering efficiency. For example, when making hard disk discs, it is more helpful to control the quality of the disc. In addition, although the present disclosure is described with the processing equipment performing the above steps of the present disclosure, the processing equipment is not limited to the above.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

1. A method of manufacturing a target material, being performed by a computer equipment, comprising:
installing a substrate;
spreading a raw material powder on the substrate by a scraper to form a powder layer, wherein the raw material powder is a powder consisting of iron, cobalt, chromium and boron with a particle size of about 20 μm to 70 μm and a powder flowability of less than 16%;
melting the raw material powder of the powder layer by a laser according to a plane size of the target material;
forming another powder layer on the substrate and the melted raw material powder;
melting a raw material powder of the another powder layer by the laser to form a desired height of the target material according to the plane size of the target material; and
cooling the target material.

2. (canceled)

3. The method of claim 1, before forming the powder layer on the substrate, further comprising:
performing a coarse screening for a coarse powder screening of the raw material powder via a coarse screen to obtain the raw material powder in fine powder form; and
performing a fine screening for a fine powder screening of the raw material powder via a fine screen to obtain the raw material.

4. The method of claim 3, wherein the coarse screening for the coarse powder screening and the fine screening for the fine powder screening are performed by an oscillating screen equipment.

5. The method of claim 1, wherein the raw material powder is stored in a powder feeding tank, and a step of forming the powder layer on the substrate is to make the scraper sequentially take out the raw material powder from the powder feeding tank that is enough to lay flat on the substrate to form the powder layer.

6. The method of claim 1, wherein the laser has a power of 140 W and a scanning speed of 900 mm/s.

7. The method of claim 1, wherein the substrate is installed in a construction cabin, and steps of forming the powder layer on the substrate, melting the powder layer by the laser and cooling the target material are performed in the construction cabin.

8. The method of claim 7, wherein the construction cabin is filled with inert gas or nitrogen gas.

9. The method of claim 1, wherein the scraper and a surface of the substrate are kept parallel to each other with a thickness formed by the powder layer as a distance.

10. The method of claim 1, before installing the substrate, further comprising:
grinding a surface of the substrate.
